(19) United States
(12) Patent Application Publication
(10) Pub. No.: US 2026/0285188 A1
(43) Pub. Date: Sep. 24, 2026

(54) ELECTRIC BOAT SYSTEM FOR CONTROLLING CHARGING AND DISCHARGING

(71) Applicant: Honda Motor Co., Ltd., Tokyo (JP)

(72) Inventor: Mark KISILER, Torrance, CA (US)

(73) Assignee: Honda Motor Co., Ltd., Tokyo (JP)

(21) Appl. No.: 19/087,855

(22) Filed: Mar. 24, 2025

(51) Int. Cl. B60L 53/67; B60L 53/51; B60L 53/62; B60L 53/63; B60L 53/64; B60L 55/00; H02J 3/32

(52) U.S. Cl. CPC B60L 53/67; B60L 53/51; B60L 53/62; B60L 53/63; B60L 53/64; B60L 55/00; H02J 3/322; B60L 2200/32

(57) ABSTRACT

A method for charging-discharging units to charge and discharge battery packs of electric boats is provided. The method may connect each of the battery packs of the electric boats to a corresponding charging-discharging unit. The method may use the corresponding charging-discharging unit for bi-directional charging. The corresponding charging unit directs power to a corresponding battery pack of a reciprocal electric boat in a first direction and in a second direction back to an electrical grid.

### BACKGROUND

The boat market may generally refer to the sector of the economy focused on the production, sale, and distribution of various types of watercrafts designed for recreational and commercial activities. The global boats market size has been valued at USD 32.47 billion in 2023. The market may be projected to grow from USD 34.25 billion in 2024 to USD 61.19 billion by 2032, exhibiting a compound annual growth rate (CAGR) of 7.5% during the forecast period.

Motorized boats may make up a large percentage of the recreational boating market. While combustion powered boats make up a large percentage of motorized boats, electric boats may offer an alternative to combustion powered boats. Electric boats may offer benefits such as zero emissions, quiet operation, low maintenance, and potential long-term cost savings, making electric boats an appealing option for environmentally conscious boaters and those seeking a peaceful boating experience. The electric boat market has been valued at USD 3.80 billion in 2024, and may be expected to reach USD 7.79 billion by 2030, rising to a CAGR of 12.77%. The rising urbanization, improved standards of living, and increased disposable income may be driving the demand for recreational boating activities

When not in use, some boat owners may store their boats in an indoor storage facility. These facilities may offer a secure, climate-controlled environment for boat storage. Indoor storage facilities may protect boats from the elements, theft, and vandalism, and can help maintain the condition of the boat as opposed to outdoor boat storage or marina slips.

When placed in storage and not in use, electric boats may become a stranded power asset. The average battery size for electric boats may vary depending on the size of the electric boat, intended use, and motor power, but a common range for smaller electric boats may be around 48V to 72V, with capacities ranging from 100Ah to 200Ah. Larger boats and those with higher power requirements may need batteries in the hundreds of kWh. Thus, the electric boat may be used as a battery energy storage system (BESS) when not being used.

Thus, it may be beneficial to provide a vehicle to grid (V2G) system that may utilize the battery packs of stored electric boats. The V2G system may control charging and discharging of the battery packs of the stored electric boats to increase the battery life of the electric boats.

Limitations and disadvantages of conventional and traditional approaches will become apparent to one of skill in the art, through comparison of described system and method with some aspects of the present disclosure, as set forth in the remainder of the present application and with reference to the drawings.

### SUMMARY

According to an embodiment of the disclosure, a method for charging-discharging units to charge and discharge battery packs of electric boats is provided. The method may connect each of the battery packs of the electric boats to a corresponding charging-discharging unit. The method may use the corresponding charging-discharging unit for bi-directional charging. The corresponding charging unit may direct power to a corresponding battery pack of a reciprocal electric boat in a first direction and in a second direction back to an electrical grid.

According to another embodiment of the disclosure, a vehicle to grid (V2G) system is provided. The V2G system may have a plurality of electric boats, each electric boat may have a corresponding battery pack. The V2G system may have a plurality of charging-discharging units. Each charging-discharging unit is removably coupled to a corresponding electric boat. Each charging-discharging unit allows for bi-directional charging directing power to a corresponding battery pack of the corresponding electric boat in a first direction and in a second direction back to an electrical grid. Each of the corresponding battery packs are categorized into different monetization stacks for performing different functions for stability of the grid when the power is sent in the second direction back to the electrical grid. The different monetization stacks are categorized based on price per kilowatt-hour (kWh).

According to another embodiment of the disclosure, a method for charging-discharging units to charge and discharge battery packs of electric boats is provided. The method may connect the battery packs of each of the electric boats to a corresponding charging-discharging unit. The method may use the corresponding charging-discharging unit for bi-directional charging, the corresponding charging unit directing power to a corresponding battery pack of a reciprocal electric boat in a first direction and in a second direction back to an electrical grid. The method may categorize the battery packs into monetization stacks based on price per kWh, the monetization stacks used for frequency regulation, peak shaving, energy arbitrage, demand response, renewable integration, capacity market, and backup power. The method may prioritize a first group of the monetization stacks generating a higher price per kWh from a second group generating a lower price per kWh.

### BRIEF DESCRIPTION OF THE DRAWINGS

FIG. 1 shows a block diagram of an exemplary vehicle to grid (V2G) system that utilizes the battery packs of stored electric boats, in accordance with an embodiment of the disclosure;

FIG. 2 shows a block diagram of an exemplary battery charging-discharging unit used in the system of FIG. 1, in accordance with an embodiment of the disclosure; and

FIG. 3 is an exemplary flowchart for controlling the charging and discharging of the electric boats shown in FIG. 1, in accordance with an embodiment of the disclosure.

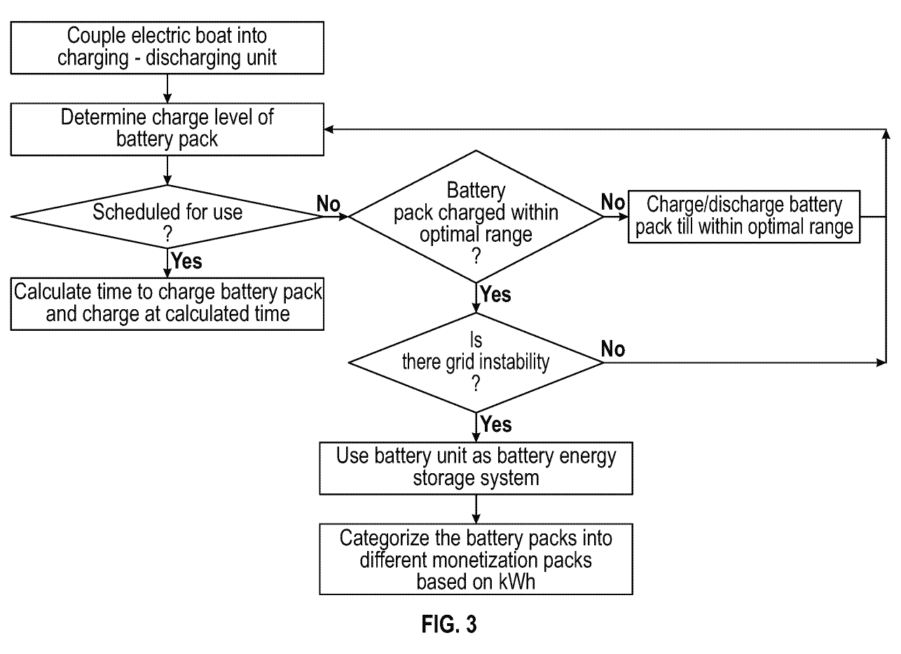

The foregoing summary, as well as the following detailed description of the present disclosure, is better understood when read in conjunction with the appended drawings. For the purposes of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

Exemplary aspects of the disclosure may provide a vehicle to grid (V2G) system that may utilize the battery packs of stored electric boats. The V2G system may control charging and discharging of the battery packs of the stored electric boats for monetization and to increase the battery life of the electric boats.

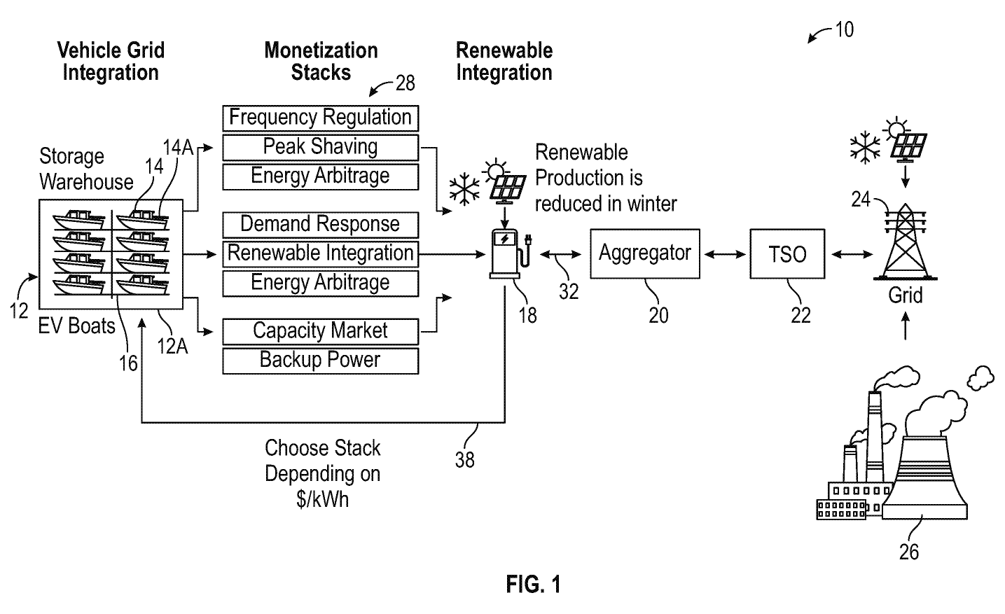

Referring to FIG. 1, an exemplary vehicle to grid (V2G) system 10 (herein system 10) may be shown. The system 10 may utilize the battery packs 14A of stored electric boats 14. The system 10 may have a boat storage 12. The boat storage 12 may be an area for the temporary or seasonal storing of electric boats 14 on land. The boat storage 12 may be a dry storage which may involve storing the electric boats 14 out of the water. To increase the number of electric boats 14 in dry storage, the electric boats 14 may be stacked vertically in racks 16 thereby increasing the overall potential of the system 10. The boat storage 12 may be an indoor boat storage 12A. The indoor boat storage 12A may store the electric boats 14 inside a fully enclosed facility, offering protection from the elements and may provide better security than outdoor storage.

The electric boats 14 may be removably coupled to a charging-discharging unit 18. Each electric boat 14 stored in the indoor boat storage 12A may be removably coupled to a corresponding charging-discharging unit 18. The charging-discharging unit 18 may be used to manage charging and discharging strategies for a battery pack 14A of the electric boat 14. The charging-discharging unit 18 may be used to estimate energy consumption of the battery pack 14A, control charging and discharging of the battery pack 14A to extend usage of the battery pack 14A, use the battery pack 14A as a battery energy storage system (BESS), monetization of the use of the energy stored in the battery pack 14A, other features as may be disclosed below.

The charging-discharging units 18 may be coupled to an aggregator 20. The aggregator 20 may act as a digital intermediary, connecting the electric boats 14 to a power grid 24. This may allow the energy stored in the battery packs 14A of the electric boats 14 to participate in grid services and energy trading potentially earning revenue by selling excess energy back to the power grid 24 as may be described below.

A Transmission System Operator (TSO) 22 may be positioned between the aggregator 20 and the power grid 24. The TSO 22 may be responsible for transmission of electricity from a utility provider 26 via the power grid 24 to the local electricity distribution operators and to the indoor boat storage 12A.

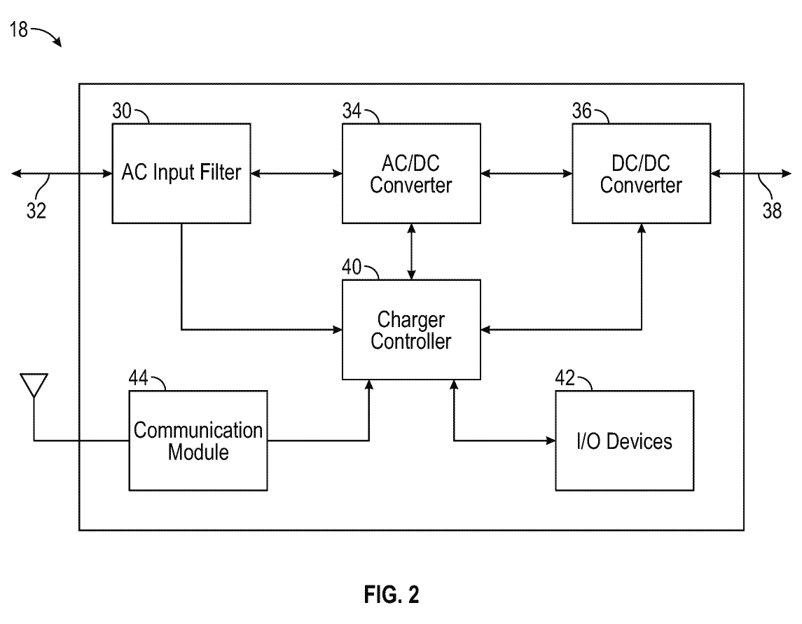

Referring to FIG. 2, the charging-discharging unit 18 may have an AC input filter 30. The AC input filter 30 may be used to suppress and filter out electrical noise from an AC power line 32. The filtered AC power may be sent to an AC/DC converter 34. The AC/DC converter 34 may transform the filtered AC power into a direct current (DC) output. The DC output may be sent to a DC/DC converter 36. The DC/DC converter 36 may take the DC output from the AC/DC converter 34 and may convert it to another DC voltage which may be sent over a power line 38 to the battery pack 14A of the electric boat 14.

The charging-discharging unit 18 may have a controller 40. The controller 40 may be used to manage charging and discharging strategies for the battery pack 14A. The controller 34 may be used to calculate energy consumption of the battery pack 14A, control charging and discharging of the battery pack 14A to extend usage of the battery pack 14A, determine when to provide a fully charged battery pack 14A at a designed time when the electric boat 14 may be removed from the indoor boat storage 12A for use on the water, when to use the battery pack 14A as a BESS, and other features as may be disclosed below.

Input/Output (I/O) devices 42 may be coupled to the controller 40. The I/O devices 42 may be used to enter and display data of the charging-discharging unit 18. For example, the I/O devices 42 may be a keypad, a display, or similar devices to enter data, receive data, and/or display data of the charging-discharging unit 18. The charging-discharging unit 18 may have a communication device 44. The communication device 44 may allow data exchange between the charging-discharging unit 18 and external devices as may be described below.

When the battery pack 14A of the electric boat 14 is coupled to the charging-discharging unit 18 via the power line 38, the charging-discharging unit 18 may monitor the current charge level of the battery pack 14A. Based on the current charge level, the charging-discharging unit 18 may determine charging and discharging strategies for the battery pack 14A. The charging-discharging unit 18 may calculate the desired state of charge for the battery pack 14A. The desired state of charge for the battery pack 14A may be based on varies factors. For example, while the maximum charge level of a typical rechargeable battery may be 100%, the desired charge level for the rechargeable battery pack 14A may be around 20% to 80% of the maximum charge level. Keeping the charge level between the 20%-80% range may enhance the life of the battery pack 14A by minimizing stress on the battery pack 14A during charging cycles. Thus, the charging-discharging unit 18 may be used to safeguard the battery pack 14A, when connected to the charging-discharging unit 18, and maintain a charge level between the desired charge level range. In the above example, the desired range may be between 20%-80%, which may extend the life of the battery pack 14A.

If the charging-discharging unit 18 determines that the current charge level of the battery pack 14A is above the desired charge level range, the charging-discharging unit 18 may determine a discharging strategy for the battery pack 14A. For example, the charging-discharging unit 18 and/or the electric boat 14 may have a discharge function which may allow the current charge level of the battery pack 14A to be lowered so that it is between the desired range. The current charge level of the battery pack 14A may be lowered by using the power from the battery pack 14A to power desired devices within and around the boat storage 12. Power from the battery pack 14A may be used to send power back to the grid 24 as may be disclosed below. Once the charge level is within the desired range, the charging-discharging unit 18 may discontinue discharging the battery pack 14A.

The charging-discharging unit 18 may calculate the drain rate of the battery pack 14A and determine when the battery pack 14A may fall below the desired charge level range. Prior to when the battery pack 14A may fall below the desired charge level range, the charging-discharging unit 18 may be configured to charge the battery pack 14A until the charge level is within the desired range. The charging-discharging unit 18 may be configured to keep the battery pack 14A charged within the range of the desired charge level while trying to minimize charging cost. For example, if the charging-discharging unit 18 calculates that the battery pack 14A may fall below the desired minimum level during a peak usage time for the utility provider 26, the charging-discharging unit 18 may be configured to charge the battery pack 14A at an earlier off-peak usage time for the utility provider 26 to lower charging cost and to lessen the power demand of the utility provider 26. For example, if the charging-discharging unit 18 determines that the battery pack 14A may fall below a 20% charge level during a peak usage time of 2:00pm-7:00pm of the utility provider 26, the charging-discharging unit 18 may begin to charge the battery pack 14A and have the battery pack 14A charged to around an 80% charge level prior to the peak usage time.

Based on the current charge level, the charging-discharging unit 18 may calculate and plan when charging of the battery pack 14A should commence so that the battery pack 14A may be properly charged for the next time the electric boat 14 is to be removed from the indoor boat storage 12A for use on the water. A user of the system 10 may set operating parameters for electric boat 14. Using the I/O devices 42 of the charging-discharging unit 18, the user may set a schedule of when the user may plan to take the electric boat 14 out of the indoor boat storage 12A for use on the water. The user may set the desired charge level of the battery pack 14A which the user may want the battery pack 14A charged to immediately prior to the next water usage. For example, the user may want to take the electric boat 14 out of the indoor boat storage 12A for use on the water on July 4 at 10:00am. The user may want the battery pack 14A to be fully charged at 100% of capacity. Based on these settings, the charging-discharging unit 18 may calculate and plan when charging of the battery pack 14A should commence so that the battery pack 14A may be charged to the desired setting at the desired time for the next usage. The controller 40 may use the current charge level, calculate the drain rate of the battery pack 14A, and calculate charging time to the desired charge level to determine when to charge the battery pack 14A so that the battery pack 14A may be charged to the desired setting at the desired time for the next water usage. The above may be given as an example. The user may set other operating parameters than those disclosed above.

Since the user may only use the electric boat 14 during weekends, holidays, or during the summer months when the weather is warm, the battery pack 14A of the electric boat 14 may become a stranded power asset when the electric boat 14 is not being used. Thus, the battery pack 14A may be used as a BESS when the electric boat 14 is not being used. When used as a BESS, the battery pack 14A may provide power to the facilities in and around the indoor boat storage 12A and/or supply power back to the electrical grid 24 as may be disclosed below.

Since the electric boats 14 may be stored for long periods of time, such as all winter, the battery packs 14A may be used to support stability of the grid 24 and may reduce reliance on traditional energy sources, particularly during peak demand periods. Using the battery packs 14A as additional power sources may enable the utility provider 26 to incorporate more renewable energy sources, such as wind and solar. However, renewables may depend on optimum weather conditions and production from renewables may decrease during the winter months. Since the battery packs 14A may have the ability to store excess energy generated by renewable sources, like solar panels or wind turbines, and release them when needed, the battery packs 14A may address the intermittency of these sources.

The communication device 44 may receive data about a time when the utility provider 26 may experience high power demand or when the grid 24 may expect some grid instability. Grid instability may manifest in several ways, including frequency and voltage fluctuations, overloading of transmission lines, and mismatches between demand and supply. The system 10 may allow the battery packs 14A to be used as a BESS to support and enhance the stability of the grid 24 by addressing the above instability issues. The controller 40 of the charging-discharging unit 18 may be used for the monetization of the battery packs 14A.

The battery packs 14A of the electric boats 14 may be categorized into different monetization stacks 28 for performing different functions, such as frequency regulation, peak shaving, energy arbitrage, demand response, renewable integration, capacity market, and backup power. The monetization stacks 28 may be chosen based on the price per kWh. This may allow the system 10 to generate a larger amount of income by using the monetization stacks 28 generating the greater price per kWh.

When supply exceeds demand, the frequency of the grid 24 may increase. Frequency regulation may ensure that the grid 24 operates at a stable frequency, typically 50 or 60 Hz. If the monetization stack 28 is used for frequency regulation, the battery packs 14A used for frequency regulation may send power back to the grid 24 to try and balance electrical supply and demand to maintain the frequency within a specified operating range, typically 50 or 60 Hz.

Peak shaving is a strategy to try and reduce electricity consumption during peak demand periods to try to avoid spikes in energy usage and associated costs. If the monetization stack 28 is used for frequency regulation, the battery packs 14A used for peak shaving may discharge power back to the grid 24 during periods of high demand, which may reduce the need for expensive, often dirty, power sources.

Energy arbitrage may be a process where the utility provider 26 may buy electricity when prices are low, generally during off-peak hours, and sell or use the electricity when prices are higher, generally during peak demand periods. For the system 10, energy arbitrage may involve charging the battery packs 14A of the monetization stack 28 used for energy arbitrage when electricity prices are low, generally during off-peak hours, and then selling the stored energy back to the grid 24 when prices are high, generally during peak demand periods.

Demand response may refer to trying to balance the demand on the grid 24 by encouraging customers of the utility provider 26 to shift electricity demand to times when electricity is more plentiful, generally during off-peak hours. This process may be done using monetary incentives. If the monetization stack 28 is used for demand response, the battery packs 14A used for demand response may discharge power back to the grid 24 when requested, generally during peak demand periods, helping to balance the supply and reduce strain on the grid 24.

The system 10 may enhance renewable energy integration. If the monetization stack 28 is used for renewable energy integration, the battery packs 14A may feed excess power back to the grid 24 during times when renewable sources may not be available, thereby improving stability of the grid 24.

In the utility industry, a capacity market is a mechanism which may pay generators for their ability to produce electricity, not just for the electricity they generate. The capacity market may be designed to ensure sufficient electricity generation capacity exists to meet future demand. Generators are paid not only for the electricity they produce, but also for the capacity they promise to make available, incentivizing investment in new generation resources. If the monetization stack 28 is used for capacity market, the utility provider 26 may be paid for the potential capacity availability of the battery packs 14A of the monetization stack 28.

The system 10 may function as a back-up power. Using the electric boats 14 as backup power, which may be referred to as Vehicle-to-Home (V2H) or Vehicle-to-Load (V2L), may involve using the battery packs 14A to power the indoor boat storage 12A and/or other facilities there around, achieved through bidirectional charging. If the monetization stack 28 is used for back-up power, the battery packs 14A used for back-up power may discharge power back to the indoor boat storage 12A and/or other facilities there around when requested, such as during rolling blackouts, power outages, and similar events.

The use of the battery packs 14A in different monetization stacks 28 may generate different income for the system 10 based on the price per KWh received. Since some of the monetization stacks 28 may be needed during peak demand periods, these monetization stacks 28 may generate more income and may take priority over lesser revenue generating monetization stacks 28. For example, the battery packs 14A used in the monetization stacks 28 for frequency regulation, peak shaving, and energy arbitrage, may be needed during peak demand periods and thus may take priority over the battery packs 14A used in the monetization stacks 28 for capacity market and backup power.

In the system 10, electric boats 14 may be stored in indoor boat storage 12A. The battery packs 14A of the stored electric boats 14 may act as grid storage capacity that may supply electricity back to the grid 24. The battery packs 14A may be used in different monetization stacks 28 for performing different functions, such as frequency regulation, peak shaving, energy arbitrage, demand response, renewable integration, capacity market, and backup power. The monetization stacks 28 may be chosen based on the price per kWh. Priority may be given to monetization stacks 28 that may generate more income and may take priority over lesser revenue generating monetization stacks 28.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for charging-discharging units to charge and discharge battery packs of electric boats, comprising:
connecting each of the battery packs of the electric boats to a corresponding charging-discharging unit; and
using the corresponding charging-discharging unit for bi-directional charging, the corresponding charging unit directing power to a corresponding battery pack of a reciprocal electric boat in a first direction and in a second direction back to an electrical grid.

2. The method of claim 1, comprising categorizing the battery packs into different monetization stacks for performing different functions for stability of the grid.

3. The method of claim 1, comprising categorizing the battery packs into different monetization stacks for performing different functions for stability of the grid, wherein the different monetization stacks are chosen based on price per kilowatt-hour (kWh).

4. The method of claim 1, categorizing the battery packs into monetization stacks for frequency regulation, peak shaving, energy arbitrage, demand response, renewable integration, capacity market, and backup power.

5. The method of claim 1, categorizing the battery packs into monetization stacks for frequency regulation, peak shaving, energy arbitrage, demand response, renewable integration, capacity market, and backup power, wherein the monetization stacks are formed based on price per kilowatt-hour (kWh).

6. The method of claim 5, comprising prioritizing a first group of the monetization stacks generating a higher price per kWh from a second group generating a lower price per kWh.

7. The method of claim 1, comprising:
determining a desired charging level range of the corresponding battery pack by the corresponding charging-discharging unit to prolong a life of the corresponding battery pack;
determining a current charge level of the corresponding battery pack by the corresponding charging-discharging unit; and
maintaining the current charge level of the corresponding battery pack within the desired charging level range by the corresponding charging-discharging unit.

8. The method of claim 1, comprising:
determining a desired charging level range of the corresponding battery pack by the corresponding charging-discharging unit to prolong a life of the corresponding battery pack;
determining a current charge level of the corresponding battery pack by the corresponding charging-discharging unit;
calculating when the current charge level falls below the desired charging level range by the corresponding charging-discharging unit; and
charging the corresponding battery pack prior to the current charge level of the corresponding battery pack falling below the desired charging level range.

9. The method of claim 1, comprising
scheduling a date and time a corresponding electric boat is to be used;
calculating by the corresponding charging-discharging unit a charging date and time when to charge the corresponding battery pack unit so the corresponding battery pack is fully charged at the scheduled date and time; and
charging the corresponding battery pack at the calculated charging date and time.

10. The method of claim 7, wherein the desired charging level range of the corresponding battery pack is between 20% to 80% of a fully charged battery pack.

11. A vehicle to grid (V2G) system, comprising:
a plurality of electric boats, each electric boat having a corresponding battery pack; and
a plurality of charging-discharging units, each charging-discharging unit removably coupled to a corresponding electric boat, wherein each charging-discharging unit allows for bi-directional charging directing power to a corresponding battery pack of the corresponding electric boat in a first direction and in a second direction back to an electrical grid;
wherein each of the corresponding battery packs are categorized into different monetization stacks for performing different functions for stability of the grid when the power is sent in the second direction back to the electrical grid, wherein the different monetization stacks are categorized based on price per kilowatt-hour (kWh).

12. The V2G system of claim 11, wherein each of the corresponding battery packs are categorized into the different monetization stacks for frequency regulation, peak shaving, energy arbitrage, demand response, renewable integration, capacity market, and backup power.

13. The V2G system of claim 11, comprising a boat storage facility for housing the plurality of boats.

14. The V2G system of claim 11, comprising:
an indoor boat storage facility for housing the plurality of electric boats; and
a plurality of racks for storing the plurality of electric boats in vertical stacks.

15. The V2G system of claim 11, comprising an aggregator coupled to the plurality of charging-discharging units and the electrical grid.

16. The V2G system of claim 15, comprising a Transmission System Operator (TSO) positioned between the aggregator 20 and the electrical power grid.

17. A method for charging-discharging units to charge and discharge battery packs of electric boats, comprising:
connecting the battery packs of each of the electric boats to a corresponding charging-discharging unit;
using the corresponding charging-discharging unit for bi-directional charging, the corresponding charging unit directing power to a corresponding battery pack of a reciprocal electric boat in a first direction and in a second direction back to an electrical grid;
categorizing the battery packs into monetization stacks based on price per kWh, the monetization stacks used for frequency regulation, peak shaving, energy arbitrage, demand response, renewable integration, capacity market, and backup power; and
prioritizing a first group of the monetization stacks generating a higher price per kWh from a second group generating a lower price per kWh.

18. The method of claim 17, comprising:
determining a desired charging level range of the corresponding battery pack by the corresponding charging-discharging unit to prolong a life of the corresponding battery pack;
determining a current charge level of the corresponding battery pack by the corresponding charging-discharging unit; and
maintaining the current charge level of the corresponding battery pack within the desired charging level range by the corresponding charging-discharging unit.

19. The method of claim 17, comprising:
determining a desired charging level range of the corresponding battery pack by the corresponding charging-discharging unit to prolong a life of the corresponding battery pack;
determining a current charge level of the corresponding battery pack by the corresponding charging-discharging unit;
calculating when the current charge level falls below the desired charging level range by the corresponding charging-discharging unit; and
charging the corresponding battery pack prior to the current charge level of the corresponding battery pack falling below the desired charging level range.

20. The method of claim 17, comprising
scheduling a date and time a corresponding electric boat is to be used;
calculating by the corresponding charging-discharging unit a charging date and time when to charge the corresponding battery pack unit so the corresponding battery pack is fully charged at the scheduled date and time; and
charging the corresponding battery pack at the calculated charging date and time.
